(19) United States
(12) Patent Application Publication
(10) Pub. No.: US 2026/0094401 A1
(43) Pub. Date: Apr. 2, 2026

(54) OBJECT RECOGNITION SYSTEM, OBJECT RECOGNITION APPARATUS, AND OBJECT RECOGNITION METHOD

(71) Applicant: NEC Corporation, Tokyo (JP)

(72) Inventors: Junichi ABE, Tokyo (JP); Kazumine OGURA, Tokyo (JP); Koichi NIHEI, Tokyo (JP); Tatsuya FUJIMOTO, Tokyo (JP); Toshiyuki NOMURA, Tokyo (JP)

(73) Assignee: NEC Corporation, Tokyo (JP)

(21) Appl. No.: 19/333,458

(22) Filed: Sep. 19, 2025

(30) Foreign Application Priority Data
Sep. 30, 2024 (JP) 2024-171208

(51) Int. Cl. G06V 10/25; G06V 10/60; G06V 10/762

(52) U.S. Cl. CPC G06V 10/25; G06V 10/60; G06V 10/762; G06V 2201/07

(57) ABSTRACT

An object recognition system includes: an image recognition unit for generating an image bounding box by performing image recognition on image data obtained by photographing a target region; a point cloud clustering unit for generating a point cloud bounding box by performing clustering on point cloud data obtained by measuring the target region; an association unit for associating the image bounding box with the point cloud bounding box; and an output unit for outputting the image bounding box associated with the point cloud bounding box as an object recognition result based on a distance of the point cloud bounding box.

### INCORPORATION BY REFERENCE

This application is based upon and claims the benefit of priority from Japanese patent application No. 2024-171208, filed on Sep. 30, 2024, the disclosure of which is incorporated herein in its entirety by reference.

### TECHNICAL FIELD

The present disclosure relates to an object recognition system, an object recognition apparatus, an object recognition method, and a program.

### BACKGROUND ART

A technology for performing object recognition using an image photographed by a camera is used. For example, Patent Literature 1 is known as a related technology. Patent Literature 1 describes that an object recognition apparatus obtains a distance to a target object from images photographed by two cameras and performs clustering based on the obtained distance.

### CITATION LIST

### Patent Literature

[Patent Literature 1] JP 2000-357233 A

### SUMMARY

In the related technologies such as Patent Literature 1, it is assumed that the images photographed by the cameras are used. However, there is a possibility that it is difficult to perform the object recognition using only the images photographed by the cameras, for example, if the object is far away.

In view of such a problem, an example object of the present disclosure is to provide an object recognition system, an object recognition apparatus, an object recognition method, and a program capable of performing object recognition even if it is difficult to perform the object recognition using only images.

An object recognition system according to one example aspect of the present disclosure includes: an image recognition unit for generating an image bounding box by performing image recognition on image data obtained by photographing a target region; a point cloud clustering unit for generating a point cloud bounding box by performing clustering on point cloud data obtained by measuring the target region; an association unit for associating the image bounding box with the point cloud bounding box; and an output unit for outputting the image bounding box associated with the point cloud bounding box as an object recognition result based on a distance of the point cloud bounding box.

An object recognition apparatus according to one example aspect of the present disclosure includes: an image recognition unit for generating an image bounding box by performing image recognition on image data obtained by photographing a target region; a point cloud clustering unit for generating a point cloud bounding box by performing clustering on point cloud data obtained by measuring the target region; an association unit for associating the image bounding box with the point cloud bounding box; and an output unit for outputting the image bounding box associated with the point cloud bounding box as an object recognition result based on a distance of the point cloud bounding box.

An object recognition method according to one example aspect of the present disclosure includes: generating an image bounding box by performing image recognition on image data obtained by photographing a target region; generating a point cloud bounding box by performing clustering on point cloud data obtained by measuring the target region; associating the image bounding box with the point cloud bounding box; and outputting the image bounding box associated with the point cloud bounding box as an object recognition result based on a distance of the point cloud bounding box.

A program according to one example aspect of the present disclosure is a program for causing a computer to execute processing including: generating an image bounding box by performing image recognition on image data obtained by photographing a target region; generating a point cloud bounding box by performing clustering on point cloud data obtained by measuring the target region; associating the image bounding box with the point cloud bounding box; and outputting the image bounding box associated with the point cloud bounding box as an object recognition result based on a distance of the point cloud bounding box.

According to the present disclosure, object recognition can be performed even if it is difficult to perform the object recognition using only images.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a configuration diagram illustrating a configuration example of an object recognition system according to some example embodiments;

FIG. 2 is a configuration diagram illustrating a configuration example of an object recognition apparatus according to some example embodiments;

FIG. 3 is a flowchart illustrating an example of an object recognition method according to some example embodiments;

FIG. 4 is a configuration diagram illustrating a configuration example of an infrastructure cooperation system according to some example embodiments;

FIG. 5 is a configuration diagram illustrating a configuration example of an infrastructure cooperation server according to some example embodiments;

FIG. 6 is a flowchart illustrating an operation example of the infrastructure cooperation server according to some example embodiments;

FIG. 7 is a configuration diagram illustrating a configuration example of an infrastructure cooperation server according to some example embodiments;

FIG. 8 is a configuration diagram illustrating a configuration example of an infrastructure cooperation server according to some example embodiments; and

FIG. 9 is a configuration diagram illustrating an example of a hardware configuration of a computer according to some example embodiments.

### EXAMPLE EMBODIMENT

Hereinafter, example embodiments will be described with reference to drawings. In the drawings, the same elements are denoted by the same reference signs, and redundant description will be omitted as necessary.

### First Example Embodiment

A first example embodiment will be described. In the present example embodiment, outlines of some example embodiments will be described.

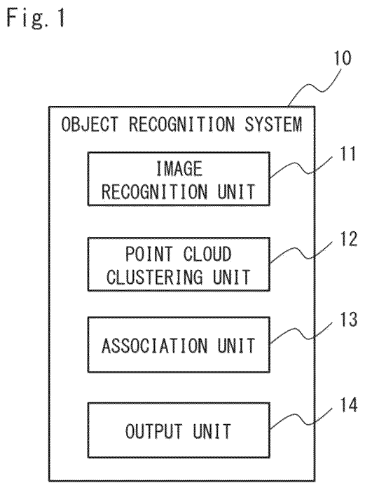

FIG. 1 illustrates a configuration example of an object recognition system 10 according to some example embodiments. For example, the object recognition system 10 is an infrastructure cooperation (road vehicle cooperation) system that processes data of a plurality of sensors on a street side (road side) or a vehicle side, but may be another system that processes data of a plurality of sensors. For example, the sensor includes a two-dimensional camera or a light detection and ranging (LiDAR), but may include other sensors.

In the example of FIG. 1, the object recognition system 10 includes an image recognition unit 11, a point cloud clustering unit 12, an association unit 13, and an output unit 14.

The image recognition unit 11 generates an image bounding box by performing image recognition on image data obtained by photographing a target region. For example, the image recognition unit 11 acquires the image data photographed by cameras and performs the image recognition on the acquired image data. The image recognition unit 11 recognizes an object in the image data by the image recognition and generates the image bounding box that is a region including the object.

The point cloud clustering unit 12 generates a point cloud bounding box by performing clustering on point cloud data obtained by measuring the target region. For example, the point cloud clustering unit 12 acquires the point cloud data from a LiDAR that measured the same region as the region photographed by the camera and clusters the acquired point cloud data. The point cloud clustering unit 12 performs the clustering based on features of the point cloud data and generates the point cloud bounding box that is a region including a point cloud cluster.

The association unit 13 associates the image bounding box generated by the image recognition of the image data with the point cloud bounding box generated by the clustering of the point cloud data. For example, the association unit 13 associates the image bounding box with the point cloud bounding box by matching or intersection over union (IoU) between the image bounding box and the point cloud bounding box.

The output unit 14 outputs the associated bounding box as an object recognition result. The output unit 14 selects a bounding box to be output among a plurality of bounding boxes. For example, the image bounding box associated with the point cloud bounding box is selected as the bounding box to be output.

The output unit 14 outputs the image bounding box associated with the point cloud bounding box as the object recognition result based on a distance of the point cloud bounding box. For example, the output unit 14 may determine a selection threshold based on the distance of the point cloud bounding box and select the image bounding box to be output based on the determined selection threshold. The selection threshold may be a threshold for determining a reliability score as an image recognition result of the image bounding box or may be a threshold for determining the IoU in a case where the image bounding box overlaps with another image bounding box.

The output unit 14 may select the image bounding box to be output based on a speed of the point cloud bounding box or an illuminance of the target region. That is, the output unit 14 may determine the selection threshold based on the speed of the point cloud bounding box or the illuminance of the target region.

The association unit 13 may associate the image bounding box with the point cloud bounding box based on the distance of the point cloud bounding box. For example, the association unit 13 may determine an association threshold based on the distance of the point cloud bounding box and associate the image bounding box with the point cloud bounding box based on the determined association threshold. The association threshold may be a threshold for determining a matching rate between the image bounding box and the point cloud bounding box or may be a threshold for determining the IoU.

The association unit 13 may associate the image bounding box with the point cloud bounding box based on the speed of the point cloud bounding box or the illuminance of the target region. That is, the association unit 13 may determine the association threshold based on the speed of the point cloud bounding box or the illuminance of the target region.

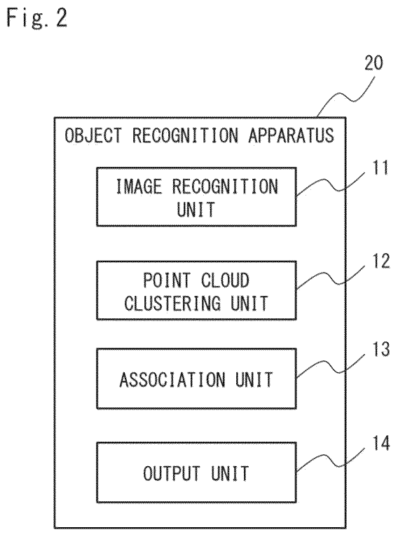

The object recognition system 10 may be configured by one device or a plurality of devices. FIG. 2 illustrates a configuration example of an object recognition apparatus 20 according to some example embodiments. In the example of FIG. 2, the object recognition apparatus 20 includes the image recognition unit 11, the point cloud clustering unit 12, the association unit 13, and the output unit 14 illustrated in FIG. 1. For example, some or all of the object recognition system 10 and the object recognition apparatus 20 may be disposed in an edge device installed at an edge or a cloud server installed in a cloud.

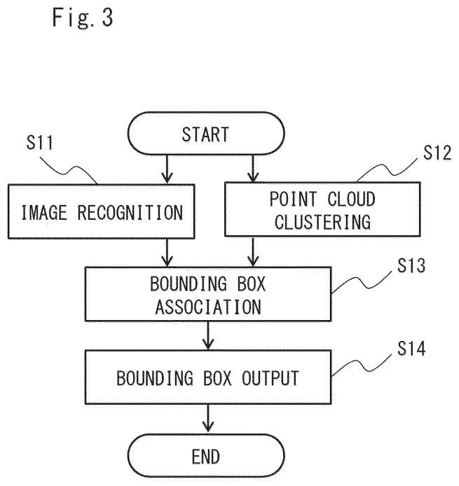

FIG. 3 illustrates a configuration example of an object recognition method according to some example embodiments. For example, the object recognition method according to some example embodiments may be executed by the object recognition system 10 in FIG. 1 or the object recognition apparatus 20 in FIG. 2.

In the example of FIG. 3, first, the image recognition unit 11 generates the image bounding box by performing the image recognition on the image data obtained by photographing the target region (S11). The point cloud clustering unit 12 generates the point cloud bounding box by performing the clustering on the point cloud data obtained by measuring the target region (S12).

Next, the association unit 13 associates the generated image bounding box with the generated point cloud bounding box (S13). Next, the output unit 14 outputs the image bounding box associated with the point cloud bounding box as the object recognition result based on the distance of the point cloud bounding box (S14).

In the related technology, if the object recognition is performed only with the images of the cameras, there is a problem that an object cannot be recognized in a far place or in a low illuminance environment and object recognition accuracy is deteriorated. For example, in a case where the object is recognized from the images and tracking is performed, since the object cannot be recognized in a far place or in a low illuminance environment, the tracking cannot be performed until the object is in a near place or in a high illuminance environment. There is a similar problem in a case where the object moves fast. Since the object that was recognized once can be tracked, in the present example embodiment, it is possible to recognize the object earlier even in a far place or in a low illuminance environment.

Therefore, in the present example embodiment, the image bounding box generated by performing the image recognition on the image data is associated with the point cloud bounding box generated by clustering the point cloud data, and the object recognition result is output from the associated image bounding box. For example, the image bounding box to be output is selected based on the distance of the point cloud bounding box. The selection threshold for selecting the image bounding box to be output may be determined based on the distance of the point cloud bounding box. The selection threshold may be determined based on the illuminance or the speed. Accordingly, it is possible to output the image bounding box as the object recognition result and perform the object recognition even in a far place or low illuminance environment. For example, if the object moves from a far place to a near place, the object recognition can be performed earlier.

In the following example embodiments, specific examples of the first example embodiment will be described.

### Second Example Embodiment

Next, a second example embodiment will be described. In the present example embodiment, an example of adjusting a threshold for determining object recognition based on a distance of an object will be described.

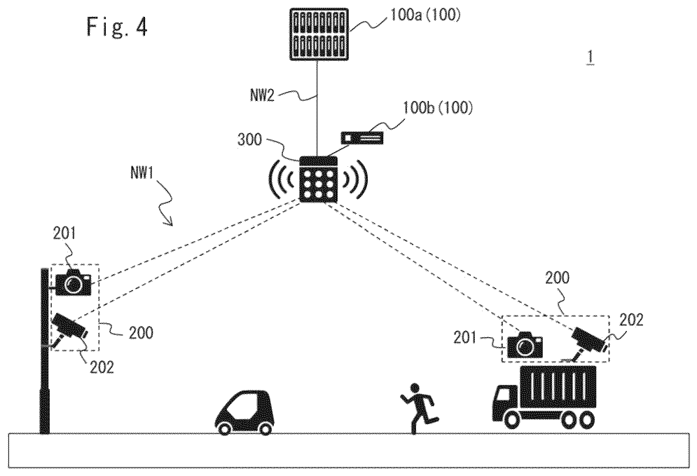

FIG. 4 illustrates a configuration example of an infrastructure cooperation system 1 according to some example embodiments. For example, the infrastructure cooperation system 1 is a system that assists traveling safety of a vehicle by combining and analyzing data collected from a plurality of sensors disposed on a street side or the vehicle. The infrastructure cooperation system 1 may be a remote monitoring system such as an intelligence transport system (ITS) that monitors roads and vehicles or a remote control system that controls vehicles according to a monitoring result. The vehicle may be an automobile, a motorcycle, a heavy machine such as a forklift, a train, a robot, a drone, or the like.

In the example of FIG. 4, the infrastructure cooperation system 1 includes a cloud server 100a, an MEC 100b, a plurality of sensors 200, and a base station 300. For example, any of the cloud server 100a and the MEC 100b configures an infrastructure cooperation server 100.

The plurality of sensors 200, the MEC 100b, and the base station 300 are disposed on the road side and the vehicle side (also referred to as a road vehicle side), and the cloud server 100a is disposed on a cloud side. For example, the cloud server 100a is disposed in a data center or the like located away from the road vehicle side. For example, the road vehicle side is an edge side with respect to the cloud.

The plurality of sensors 200 and the base station 300 are communicably connected by a network NW1. The network NW1 is, for example, a wireless network such as 4G, long term evolution (LTE), local 5G/5G, other generation mobile communication, or wireless LAN. For example, the network NW1 may be a network such as dedicated short range communication (DSRC) for the ITS system or vehicle to everything (V2X) that connects a vehicle with various objects. V2X may be long term evolution-V2X (LTE-V2X), new radio V2X (NR-V2X), cellular V2X (C-V2X), or the like. The network NW1 is not limited to the wireless network, and may be a wired network.

The base station 300 and the MEC 100b are communicably connected by any communication method. It can also be said that the sensor 200 and the MEC 100b are communicably connected via the base station 300. The base station 300 and the MEC 100b may be one device. For example, the base station 300 may include a function of the MEC 100b.

The base station 300 and the cloud server 100a are communicably connected by a network NW2. The network NW2 includes, for example, a core network such as a 5th generation core (5GC) network or an evolved packet core (EPC), the Internet, and the like. The network NW2 is not limited to a wired network, and may be a wireless network. It can also be said that the sensors 200 and the cloud server 100a are communicably connected via the base station 300 and the network NW2.

The sensors 200 may be provided in a terminal device connected to the network NW1 or may be connected to the terminal device. The sensors 200 or the terminal device may be installed on the street side or may be mounted on the vehicle. For example, the sensors 200 or the terminal device may be a road side unit (RSU) installed on the street side, or an on-board unit (OBU) mounted on the vehicle. The sensors 200 transmit measured sensor data to the MEC 100b or the cloud server 100a.

The sensors 200 include different types of sensors. For example, the sensor 200 includes a camera 201 that photographs a two-dimensional image (video) and a LiDAR 202 that generates point cloud data. The sensor is not limited to the LiDAR 202, and a three-dimensional sensor capable of acquiring three-dimensional information such as a radar and structure from motion (SfM) may be used.

The video data generated by the camera 201 includes a plurality of time-series images, that is, frames. The point cloud data generated by the LiDAR 202 includes coordinate information of a three-dimensional space obtained by reflected light from objects at points within a measurement range measured by the LiDAR. The coordinate information indicates a depth or a three-dimensional position of the points in the three-dimensional space. The point cloud data is not limited to the coordinates of the points, and may include reflectance of light at the points and the like.

The base station 300 is a base station apparatus of the network NW1, and is also a relay apparatus that relays communication between the sensors 200 and the MEC 100b or the cloud server 100a. For example, the base station 300 may be a local 5G base station, a 5G next generation node B (gNB), an LTE evolved node B (eNB), an access point of a wireless LAN, or the like, or may be another relay apparatus.

The multi-access edge computing (MEC) 100b is an edge server installed on the edge side of the system. The MEC 100b may be one or a plurality of physical computers, or may be a virtual computer built on any virtualization platform. The MEC 100b may process the sensor data including the video data and the point cloud data received from the sensor 200 and transmit the processed data to the cloud server 100a, or may control the sensor 200 as necessary.

The cloud server 100a is a server installed on the cloud side. The cloud server 100a may be one or a plurality of physical servers, or may be a virtual server built on any virtualization platform. The cloud server 100a may process the sensor data including the video data and the point cloud data received from the sensor 200 and control the sensor 200 as necessary.

The infrastructure cooperation server 100 configured by the cloud server 100a or the MEC 100b monitors a situation in a vicinity of the vehicle by analyzing and recognizing the sensor data including the video data and the point cloud data on the road vehicle side and controls the vehicle as necessary. The infrastructure cooperation server 100 includes an object recognition function (object recognition apparatus) and a tracking and prediction function. For example, the infrastructure cooperation server 100 performs the object recognition by the video data and the point cloud data, predicts movement by tracking the recognized vehicle, and predicts a situation of a pedestrian, a falling object, an animal, and the like in the vicinity of the moving vehicle.

The infrastructure cooperation server 100 may feed the predicted result back to the sensor 200 of the vehicle. The infrastructure cooperation server 100 may transmit predicted information in the vicinity of the vehicle, or may transmit control information or the like for controlling traveling of the vehicle. For example, it is possible to provide information on an obstacle or the like in a blind-spot area that cannot be recognized on the vehicle side. Even in a case where the vehicle cannot recognize the surrounding situation at night or in bad weather, autonomous traveling can be safely controlled. For example, even in a case where detection by camera images is difficult such as in a far place, various pieces of vehicle position information and hazard information can be provided by utilizing the point cloud data obtained by the LiDAR.

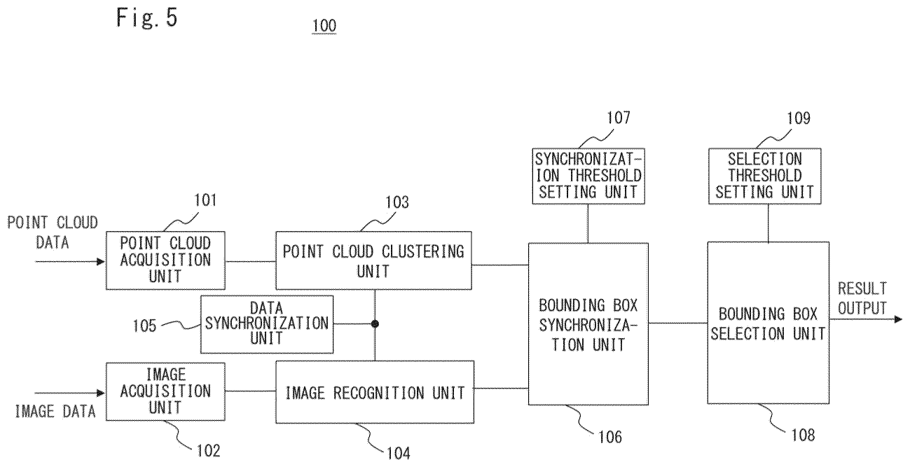

FIG. 5 illustrates a configuration example of the infrastructure cooperation server 100 according to some example embodiments. FIG. 5 illustrates a configuration example of the object recognition function (the object recognition apparatus) in the infrastructure cooperation server 100. The configuration in FIG. 5 is an example, and other configurations may be used as long as the operations according to some example embodiments can be performed. For example, some functions of the infrastructure cooperation server 100 may be provided in the sensors, the terminal connected to the sensors, or other devices.

In the example of FIG. 5, the infrastructure cooperation server 100 includes a point cloud acquisition unit 101, an image acquisition unit 102, a point cloud clustering unit 103, an image recognition unit 104, a data synchronization unit 105, a bounding box synchronization unit 106, a synchronization threshold setting unit 107, a bounding box selection unit 108, and a selection threshold setting unit 109.

The point cloud acquisition unit 101 acquires the point cloud data measured by the LiDAR 202 from the LiDAR 202. The image acquisition unit 102 acquires the image data photographed by the camera 201 from the camera 201. The point cloud acquisition unit 101 and the image acquisition unit 102 acquire the point cloud data and the image data from the LIDAR 202 and the camera 201 that measure the same region.

The point cloud clustering unit 103 performs the clustering on the point cloud data acquired by the point cloud acquisition unit 101. The point cloud clustering unit 103 generates the point cloud bounding box by performing the clustering on the point cloud based on the features. The features to be clustered are, for example, a shape, a speed, a point cloud density, and the like. The point cloud clustering unit 103 clusters the point cloud data by a clustering engine using machine learning such as deep learning, and outputs a three-dimensional rectangular region including the cluster as the point cloud bounding box. The clustering in the point cloud clustering unit 103 may be performed regarding the features having a short Euclidean distance as the same cluster. A position (three-dimensional coordinates including a distance), a speed, and the like as clustering results are assigned to the point cloud bounding box. The distance is a distance (depth) from the LiDAR to the object.

The image recognition unit 104 performs the image recognition on the image data acquired by the image acquisition unit 102. The image recognition unit 104 performs recognition of the object and generation of the image bounding box by the image recognition. The image recognition unit 104 recognizes the object by an image recognition (object recognition) engine using machine learning such as deep learning and outputs a two-dimensional rectangular region including the recognized object as the image bounding box. The image recognition unit 104 outputs all image bounding boxes generated by the image recognition engine. An object type, a position (two-dimensional coordinates), a reliability score, and the like as image recognition results are assigned to the image bounding box.

The data synchronization unit 105 synchronizes a time and a position of the point cloud data and the image data. The data synchronization unit 105 synchronizes the point cloud data and the image data obtained by measuring and photographing the same region at the same time. As for where to perform the synchronization, the point cloud data and the image data may be directly synchronized or may be synchronized after the generation of the bounding box. That is, the point cloud clustering unit 103 and the image recognition unit 104 may generate the point cloud bounding box and the image bounding box from the point cloud data and the image data obtained by measuring and photographing the same region at the same time, or may synchronize the point cloud bounding box and the image bounding box obtained in the same region at the same time from the point cloud bounding box and the image bounding box generated by the point cloud clustering unit 103 and the image recognition unit 104.

The bounding box synchronization unit 106 associates and synchronizes the point cloud bounding box generated by the point cloud clustering unit 103 with the image bounding box generated by the image recognition unit 104. That is, the point cloud bounding box and the image bounding box that may be of the same object are associated. For example, the bounding box synchronization unit 106 projects the point cloud bounding box onto the same two-dimensional plane as the image data, performs the matching between the projected two-dimensional point cloud bounding box and the image bounding box, and associates the point cloud bounding box with the image bounding box based on the IoU of the matched point cloud bounding box and image bounding box. The bounding box synchronization unit 106 may select and associate the point cloud bounding box and the image bounding box having a matching rate higher than a set value (synchronization threshold). The bounding box synchronization unit 106 may select and associate the point cloud bounding box and the image bounding box having an IoU larger than a set value (synchronization threshold). For example, speed/position information obtained by the point cloud clustering unit 103 and the object recognition information (reliability score or the like) obtained by the image recognition unit 104 may be given to the associated bounding box (image bounding box).

The synchronization threshold setting unit 107 sets the synchronization threshold (association threshold) for determining the association between the point cloud bounding box and the image bounding box by the bounding box synchronization unit 106. The bounding box synchronization unit 106 and the synchronization threshold setting unit 107 may configure an association unit. For example, the synchronization threshold setting unit 107 sets the synchronization threshold based on the distance of the point cloud bounding box. For example, the synchronization threshold according to the distance may be determined using a table in which the distance is associated with the synchronization threshold to be set, or the synchronization threshold according to the distance may be determined using a training model in which the relationship between the distance and the synchronization threshold to be set is trained. The synchronization threshold may be a threshold for determining the matching rate or a threshold for determining the IoU. For example, if the distance of the point cloud bounding box is long, that is, if the association between the point cloud bounding box that is far away and the image bounding box is determined, the synchronization threshold for determining the matching rate or the synchronization threshold for determining the IoU is set to be lower. As a result, even if the object is far away, the object can be detected earlier and tracking can be started. If the camera is a fixed camera, since the distance of the object may not change for each area in the image, the synchronization threshold based on the distance may be set for each area in the image. If the reflectance is included in the point cloud data, the synchronization threshold may be set based on the reflectance.

The bounding box selection unit 108 selects the bounding box to be output as the recognition result among the bounding boxes associated by the bounding box synchronization unit 106 (the image bounding boxes associated with the point cloud bounding box). The selected bounding box may be output to a function using the object recognition result (such as tracking) or other devices. For example, the selected bounding box may be displayed on a display device. For example, the bounding box selection unit 108 may select the bounding box to be output based on the reliability score of the bounding box, or may select the bounding box to be output based on the IoU of the bounding box. The bounding box selection unit 108 may select and output the bounding box having a reliability score larger than a set value (selection threshold). The bounding box selection unit 108 may determine the IoU in a case where a plurality of bounding boxes overlap, and select any or all of the overlapping bounding boxes if the IoU is larger than a set value (selection threshold).

The selection threshold setting unit 109 sets the selection threshold for determining the bounding box to be output by the bounding box selection unit 108. The bounding box selection unit 108 and the selection threshold setting unit 109 may configure an output unit. For example, the selection threshold setting unit 109 sets the selection threshold based on the distance of the bounding box. For example, the selection threshold according to the distance may be determined using a table in which the distance is associated with the selection threshold to be set, or the selection threshold according to the distance may be determined using a training model in which the relationship between the distance and the selection threshold to be set is trained. The selection threshold may be a threshold for determining the reliability score or a threshold for determining the IoU. For example, if the distance of the bounding box is long, the selection threshold for determining the reliability score or the selection threshold for determining the IoU is set to be lower. As a result, even if the object is far away, the object can be detected earlier and tracking can be started. Similarly to the synchronization threshold, if the camera is a fixed camera, the selection threshold based on the distance may be set for each area in the image. If the reflectance is included in the point cloud data, the synchronization threshold may be set based on the reflectance.

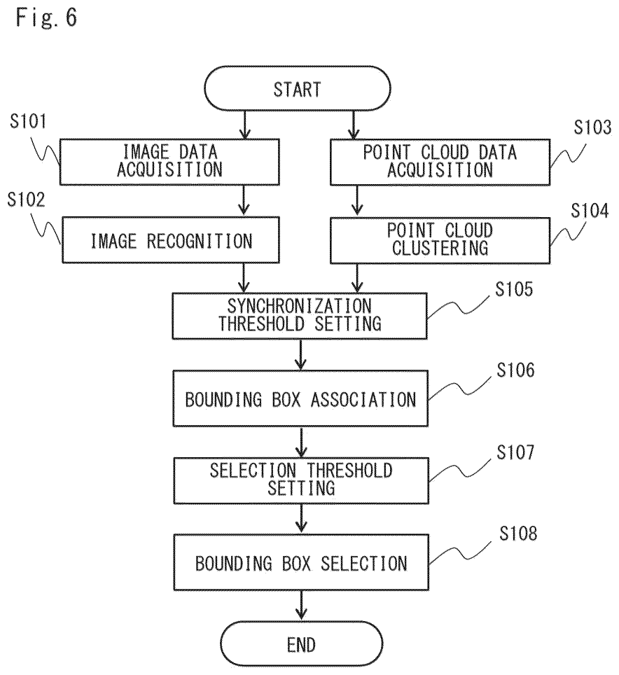

FIG. 6 illustrates an operation example of the infrastructure cooperation server 100 according to some example embodiments. In the example of FIG. 6, first, the infrastructure cooperation server 100 acquires the image data (S101), and performs the image recognition on the acquired image data (S102). For example, the image acquisition unit 102 acquires the image data from the camera 201. The image recognition unit 104 performs the image recognition on the acquired image data, recognizes the object, and generates the image bounding box.

The infrastructure cooperation server 100 acquires the point cloud data (S103), and performs the clustering on the acquired point cloud data (S104). For example, the point cloud acquisition unit 101 acquires the point cloud data from the LiDAR 202. The point cloud clustering unit 103 generates the point cloud bounding box by performing the clustering on the acquired point cloud based on the features. S101 to S102 may be executed simultaneously with S103 to S104, or either may be executed first.

Subsequently, the infrastructure cooperation server 100 sets the synchronization threshold based on the distance of the generated point cloud bounding box (S105). For example, the distance of the point cloud bounding box is assigned to the point cloud bounding box during the clustering. For example, if the distance of the point cloud bounding box is longer than a predetermined distance, the synchronization threshold setting unit 107 sets the synchronization threshold to be lower. The synchronization threshold setting unit 107 may set either or both of the synchronization threshold for determining the matching rate and the synchronization threshold for determining the IoU.

Subsequently, the infrastructure cooperation server 100 associates the generated point cloud bounding box with the generated image bounding box using the set synchronization threshold (S106). For example, the bounding box synchronization unit 106 may perform the matching between the point cloud bounding box and the image bounding box and associate the point cloud bounding box and the image bounding box that match at a matching rate higher than the synchronization threshold. The bounding box synchronization unit 106 may calculate the IoU of the matched point cloud bounding box and image bounding box and associate the point cloud bounding box and the image bounding box that overlap by an IoU larger than the synchronization threshold.

Subsequently, the infrastructure cooperation server 100 sets the selection threshold based on the distance of the point cloud bounding box (S107). For example, the distance of the point cloud bounding box is assigned to the point cloud bounding box during the clustering. The distance may be a distance given to the associated bounding box (image bounding box). For example, if the distance of the point cloud bounding box is longer than a predetermined distance, the selection threshold setting unit 109 sets the selection threshold to be lower. The selection threshold setting unit 109 may set either or both of the selection threshold for determining the reliability score and the selection threshold for determining the IoU.

Subsequently, the infrastructure cooperation server 100 selects the bounding box to be output using the set selection threshold (S108). For example, if the reliability score of the image bounding box with which the point cloud bounding box is associated is larger than the selection threshold, the bounding box selection unit 108 may select and output the bounding box. The bounding box selection unit 108 may calculate the IoU in a case where a plurality of image bounding boxes overlap, and select and output any or all of the overlapping bounding boxes if the calculated IoU is larger than the selection threshold.

As described above, in the present example embodiment, in recognition of a vehicle, a person, or the like in a two-dimensional image, clustering is performed on a point cloud of a LiDAR by a moving speed, a point cloud density, a shape, or the like, and a recognition result for a far object (cluster) can be displayed even regarding a bounding box having a low reliability score of image recognition or a low IoU. By making the reliability score for displaying the recognition result and the threshold level of the IoU to be variable according to the distance of the far object, it is possible to detect the far object with priority given to tracking rather than recognition accuracy, and it is possible to enhance safety of autonomous driving and the like. In a case where the tracking is performed, by performing the recognition once, it is possible to perform the tracking earlier even if the reliability of the recognition is low. In a case where the distance of the object becomes closer, the threshold level can be adjusted again, and it is possible to perform early recognition at a far place without deteriorating the recognition accuracy at a near place. A similar effect can be obtained by adjusting the threshold level for associating the image bounding box with the point cloud bounding box.

### Third Example Embodiment

Next, a third example embodiment will be described. In the present example embodiment, an example of adjusting a threshold for determining object recognition based on a speed of an object will be described.

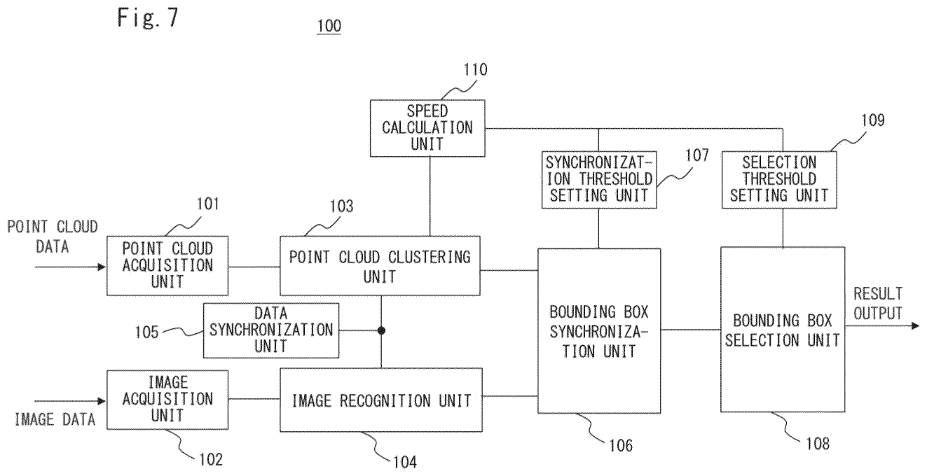

FIG. 7 illustrates a configuration example of an infrastructure cooperation server 100 according to some example embodiments. In the example of FIG. 7, the infrastructure cooperation server 100 includes a speed calculation unit 110 in addition to the configuration of FIG. 5. The rest of the configuration is the same as in the second example embodiment.

The speed calculation unit 110 calculates a speed of the point cloud bounding box generated by the point cloud clustering unit 103. For example, a past point cloud bounding box is stored in a storage unit, and a moving speed is calculated from a moving amount and a time of the point cloud bounding box. The speed calculation unit 110 may acquire the moving speed from the clustering result of the point cloud bounding box.

In the present example, the synchronization threshold setting unit 107 sets the synchronization threshold based on the speed of the point cloud bounding box. The synchronization threshold setting unit 107 may set the synchronization threshold based on the distance and the speed of the point cloud bounding box, or may set the synchronization threshold based only on the speed of the point cloud bounding box. For example, if the speed of the point cloud bounding box is high, the synchronization threshold for determining the matching rate or the synchronization threshold for determining the IoU is set to be lower. As a result, it is possible to detect a fast moving object earlier and start the tracking.

The selection threshold setting unit 109 sets the selection threshold based on the speed of the point cloud bounding box. The selection threshold setting unit 109 may set the selection threshold based on the distance and the speed of the point cloud bounding box, or may set the selection threshold based only on the speed of the point cloud bounding box. For example, if the speed of the point cloud bounding box is high, the selection threshold for determining the reliability score or the selection threshold for determining the IoU is set to be lower. As a result, it is possible to detect a fast moving object earlier and start the tracking. As such, the threshold level to be set may be variable according to the moving speed of the object. For example, the threshold level may not be changed for a far cluster (object) that does not move or a slow cluster such as a pedestrian, and the threshold level may be changed only for the fast moving cluster assumed to have a high risk. As a result, the fast moving object having a high risk can be recognized earlier.

### Fourth Example Embodiment

Next, a fourth example embodiment will be described. In the present example embodiment, an example of adjusting a threshold for determining object recognition based on a measurement environment of an object will be described.

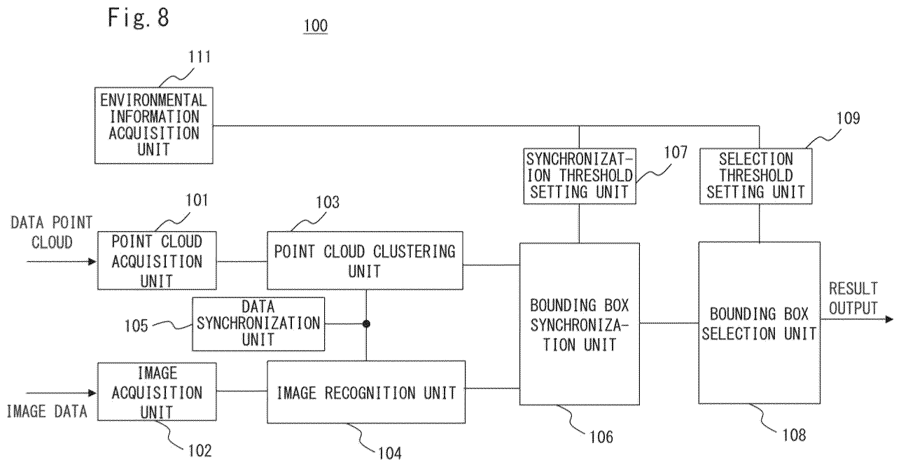

FIG. 8 illustrates a configuration example of an infrastructure cooperation server 100 according to some example embodiments. In the example of FIG. 8, the infrastructure cooperation server 100 includes an environmental information acquisition unit 111 in addition to the configuration of FIG. 5. The rest of the configuration is the same as in the second and third example embodiments.

The environmental information acquisition unit 111 acquires environmental information regarding the measurement environment of the camera 201. For example, the environmental information is an illuminance in a vicinity of the camera 201. The environmental information is not limited to the illuminance, and may be a photographing time or weather. For example, the environmental information acquisition unit 111 may acquire the environmental information from the camera 201 or may acquire the environmental information from another device. For example, the illuminance may be acquired from an illuminance sensor installed near the camera 201. The photographing time may be acquired together with the image data from the camera 201. The weather may be acquired from a server that manages the weather at each point or the like.

In the example, for example, the synchronization threshold setting unit 107 sets the synchronization threshold based on the environmental information. The synchronization threshold setting unit 107 may set the synchronization threshold based on the distance (speed) of the point cloud bounding box and the environmental information, or may set the synchronization threshold based only on the environmental information. For example, if the illuminance is low (dark), the synchronization threshold for determining the matching rate or the synchronization threshold for determining the IoU is set to be lower. Similarly, the synchronization threshold may be set to be lower in cases such as an excessive illuminance (a car headlight or the like), a bad weather, or a nighttime. As a result, even in a dark environment or the like, it is possible to detect the object earlier and start the tracking. It is also possible to reduce an influence of the car headlight or the like.

The selection threshold setting unit 109 sets the selection threshold based on the environmental information. The selection threshold setting unit 109 may set the selection threshold based on the distance (speed) of the point cloud bounding box and the environmental information, or may set the selection threshold based on the environmental information. For example, if the illuminance is low, the selection threshold for determining the reliability score or the selection threshold for determining the IoU is set to be lower. The selection threshold may be set similarly even in cases such as an excessive illuminance, a bad weather, or a nighttime. As a result, even in a dark environment or the like, it is possible to detect the object and start the tracking. It is also possible to reduce the influence of the car headlight or the like.

As such, the threshold level to be set may be variable according to the environment such as the illuminance, the time, and the weather. For example, in a case of a low illuminance such as a bad weather or a nighttime, the threshold level is lowered from a short distance. As a result, the tracking of a dangerous object can be prioritized over the recognition accuracy.

The present disclosure is not limited to the above-described example embodiments, and can be appropriately modified without departing from the scope. For example, in the above example embodiments, the threshold is determined based on the distance or the like, but a comparison target (reliability score or the like) of the threshold may be adjusted based on the distance or the like.

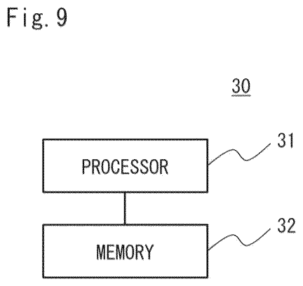

Each configuration in the above-described example embodiments may be implemented by hardware, software, or both, and may be implemented by one piece of hardware or software or by a plurality of pieces of hardware or software. The functions (processing) of the sensor, the infrastructure cooperation server, and the like may be implemented by a computer 30 including a processor 31 such as a central processing unit (CPU) and a memory 32 as a storage device as illustrated in FIG. 9. For example, a program for performing the method of the example embodiment may be stored in the memory 32, and each of the functions may be achieved by executing the program stored in the memory 32 by the processor 31.

The program described above includes commands (or software codes) for causing a computer to perform one or more functions described in the example embodiments in a case where the program is read by the computer. The program may be stored in a non-transitory computer readable medium or a tangible storage medium. As an example and not by way of limitation, the computer-readable medium or the tangible storage medium includes a random-access memory (RAM), a read-only memory (ROM), a flash memory, a solid-state drive (SSD) or other memory technology, a compact disc read-only memory (CD-ROM), a digital versatile disc (DVD), a Blu-ray (registered trademark) disc or any other optical disc storage, a magnetic cassette, a magnetic tape, a magnetic disc storage, or other magnetic storage devices. The program may be transmitted via a transitory computer-readable medium or a communication medium. As an example and not by way of limitation, the transitory computer-readable medium or the communication medium includes electrical, optical, or acoustic signals or propagated signals in other forms.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example to illustrate one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All of the features or the steps illustrated in any one of the drawings for describing illustrative example embodiments are not necessarily mandatory, and some features or steps may be omitted. The order of the steps described in any of the drawings may be changed as appropriate.

Some or all of the above example embodiments may also be described as the following Supplementary Notes, but are not limited to the following.

### Supplementary Note 1

An object recognition system including:
an image recognition unit for generating an image bounding box by performing image recognition on image data obtained by photographing a target region;
a point cloud clustering unit for generating a point cloud bounding box by performing clustering on point cloud data obtained by measuring the target region;
an association unit for associating the image bounding box with the point cloud bounding box; and
an output unit for outputting the image bounding box associated with the point cloud bounding box as an object recognition result based on a distance of the point cloud bounding box.

### Supplementary Note 2

The object recognition system according to supplementary note 1, wherein the output unit determines a selection threshold based on the distance of the point cloud bounding box and selects the image bounding box to be output based on the determined selection threshold.

### Supplementary Note 3

The object recognition system according to supplementary note 2, wherein the selection threshold is a threshold for determining a reliability score that is an image recognition result of the image bounding box or an IoU in a case where the image bounding box overlaps another image bounding box.

### Supplementary Note 4

The object recognition system according to any one of supplementary notes 1 to 3, wherein the output unit selects the image bounding box to be output based on a speed of the point cloud bounding box.

### Supplementary Note 5

The object recognition system according to any one of supplementary notes 1 to 3, wherein the output unit selects the image bounding box to be output based on an illuminance of the target region.

### Supplementary Note 6

The object recognition system according to any one of supplementary notes 1 to 3, wherein the association unit associates the image bounding box with the point cloud bounding box based on the distance of the point cloud bounding box.

### Supplementary Note 7

The object recognition system according to supplementary note 6, wherein the association unit determines an association threshold based on the distance of the point cloud bounding box and associates the image bounding box with the point cloud bounding box based on the determined association threshold.

### Supplementary Note 8

The object recognition system according to supplementary note 7, wherein the association threshold is a threshold for determining a matching rate between the image bounding box and the point cloud bounding box or the IoU.

### Supplementary Note 9

The object recognition system according to any one of supplementary notes 1 to 3, wherein the association unit associates the image bounding box with the point cloud bounding box based on a speed of the point cloud bounding box.

### Supplementary Note 10

The object recognition system according to any one of supplementary notes 1 to 3, wherein the association unit associates the image bounding box with the point cloud bounding box based on an illuminance of the target region.

### Supplementary Note 11

An object recognition apparatus including:
an image recognition unit for generating an image bounding box by performing image recognition on image data obtained by photographing a target region;
a point cloud clustering unit for generating a point cloud bounding box by performing clustering on point cloud data obtained by measuring the target region;
an association unit for associating the image bounding box with the point cloud bounding box; and
an output unit for outputting the image bounding box associated with the point cloud bounding box as an object recognition result based on a distance of the point cloud bounding box.

### Supplementary Note 12

An object recognition method including:
generating an image bounding box by performing image recognition on image data obtained by photographing a target region;
generating a point cloud bounding box by performing clustering on point cloud data obtained by measuring the target region;
associating the image bounding box with the point cloud bounding box; and
outputting the image bounding box associated with the point cloud bounding box as an object recognition result based on a distance of the point cloud bounding box.

### (Supplementary Note 13)

A program for causing a computer to execute processing including:
generating an image bounding box by performing image recognition on image data obtained by photographing a target region;
generating a point cloud bounding box by performing clustering on point cloud data obtained by measuring the target region;
associating the image bounding box with the point cloud bounding box; and outputting the image bounding box associated with the point cloud
bounding box as an object recognition result based on a distance of the point cloud bounding box.

Some or all of the elements (for example, configurations and functions) described in Supplementary Notes 2 to 10 dependent on Supplementary Note 1 (object recognition system) can also be dependent on Supplementary Note 11 (object recognition apparatus), Supplementary Note 12 (object recognition method), and Supplementary Note 13 (program) by the same dependency relationship as Supplementary Notes 2 to 10. Some or all of the elements described in any Supplementary Note may be applied to various types of hardware, software, recording means for recording software, systems, and methods.

What is claimed is:

1. An object recognition system comprising:
a memory configured to store instructions; and
a processor configured to execute the instructions to:
generate an image bounding box by performing image recognition on image data obtained by photographing a target region;
generate a point cloud bounding box by performing clustering on point cloud data obtained by measuring the target region;
associate the image bounding box with the point cloud bounding box; and
output the image bounding box associated with the point cloud bounding box as an object recognition result based on a distance of the point cloud bounding box.

2. The object recognition system according to claim 1, wherein the processor is further configured to execute the instructions to determine a selection threshold based on the distance of the point cloud bounding box and select the output image bounding box based on the determined selection threshold.

3. The object recognition system according to claim 2, wherein the selection threshold is a threshold for determining a reliability score that is an image recognition result of the image bounding box or an IoU in a case where the image bounding box overlaps another image bounding box.

4. The object recognition system according to claim 1, wherein the processor is further configured to execute the instructions to select the output image bounding box based on a speed of the point cloud bounding box.

5. The object recognition system according to claim 1, wherein the processor is further configured to execute the instructions to select the output image bounding box based on an illuminance of the target region.

6. The object recognition system according to claim 1, wherein the processor is further configured to execute the instructions to associate the image bounding box with the point cloud bounding box based on the distance of the point cloud bounding box.

7. The object recognition system according to claim 6, wherein the processor is further configured to execute the instructions to determine an association threshold based on the distance of the point cloud bounding box and associate the image bounding box with the point cloud bounding box based on the determined association threshold.

8. The object recognition system according to claim 7, wherein the association threshold is a threshold for determining a matching rate between the image bounding box and the point cloud bounding box or an IoU.

9. The object recognition system according to claim 1, wherein the processor is further configured to execute the instructions to associate the image bounding box with the point cloud bounding box based on a speed of the point cloud bounding box.

10. The object recognition system according to claim 1, wherein the processor is further configured to execute the instructions to associate the image bounding box with the point cloud bounding box based on an illuminance of the target region.

11. An object recognition apparatus comprising:
a memory configured to store instructions; and
a processor configured to execute the instructions to:
generate an image bounding box by performing image recognition on image data obtained by photographing a target region;
generate a point cloud bounding box by performing clustering on point cloud data obtained by measuring the target region;
associate the image bounding box with the point cloud bounding box; and
output the image bounding box associated with the point cloud bounding box as an object recognition result based on a distance of the point cloud bounding box.

12. An object recognition method comprising:
generating an image bounding box by performing image recognition on image data obtained by photographing a target region;
generating a point cloud bounding box by performing clustering on point cloud data obtained by measuring the target region;
associating the image bounding box with the point cloud bounding box; and
outputting the image bounding box associated with the point cloud bounding box as an object recognition result based on a distance of the point cloud bounding box.
